(19) United States
(12) Patent Application Publication
(10) Pub. No.: US 2021/0100264 A1
(43) Pub. Date: Apr. 8, 2021

(54) A SOLID FEED COMBINATION COMPOSITION FOR RUMINANT CALVES

(71) Applicant: Nutreco IP Assets B.V., Boxmeer (NL)

(72) Inventors: Javier Martín-Tereso López, BOXMEER (NL); Harmina Berends, Wageningen (NL); Leonel Neto Leal, Nijmegen (NL)

(21) Appl. No.: 16/607,945

(22) PCT Filed: Apr. 26, 2018
(86) PCT No.: PCT/EP2018/060745

§ 371 Date: Oct. 24, 2019

(30) Foreign Application Priority Data
Apr. 26, 2017 (EP) 17168256.0

(51) Int. Cl. A23K 10/30; A23K 40/25; A23K 50/10; A23K 20/163; A23K 20/158

(52) U.S. Cl. CPC A23K 10/30; A23K 40/25; A23K 20/158; A23K 20/163; A23K 50/10

(57) ABSTRACT

This disclosure relates to use of a fat-enriched, solid feed combination composition comprising at least a first solid feed composition, which is in the form of a pellet, comprising one or more fermentable feed ingredients, and a second solid feed composition, wherein the first composition comprises between 20 and 90 wt. % of fat and wherein the second composition comprises one or more fermentable feed ingredients, and wherein the total fat content of the solid feed combination is in the range of 5-20 wt. %, for feeding a ruminant calf. The solid feed combination composition of the disclosure is particularly suitable for ingestion by a ruminant calf during and/or after the weaning period and can be advantageously used in methods carried out during and/or after the weaning period for: 1) for decreasing weaning stress in a ruminant calf, 2) for preventing a decrease in body weight and/or somatic growth of a ruminant calf, 3) for increasing solid feed intake of a ruminant calf, 4) for maturing the rumen of a ruminant calf, and 5) for improving the gut health and/or the gastrointestinal function of a ruminant calf.

### CROSS-REFERENCE TO RELATED APPLICATIONS

This application is a national phase entry under 35 U.S.C. § 371 of International Patent Application PCT/EP2018/060745, filed Apr. 26, 2018, designating the United States of America and published as International Patent Publication WO 2018/197620 A1 on Nov. 1, 2018, which claims the benefit under Article 8 of the Patent Cooperation Treaty to European Patent Application Serial No. 17168256.0, filed Apr. 26, 2017.

### TECHNICAL FIELD

This disclosure relates to the field of starter feed composition or starter feed supplement for ruminant calves (e.g., e.g., dairy calf, beef calf). Specifically, this disclosure relates to a fat-enriched, solid feed combination composition suitable for ingestion by a ruminant calf during and/or after the weaning period and uses thereof in methods carried out during the weaning period and/or after the weaning period for: 1) for decreasing weaning stress, 2) for increasing body weight and/or for increasing somatic growth, 3) for increasing solid feed intake, 4) for maturing the rumen, 5) for improving the gut health and/or the gastrointestinal function of a ruminant calf, 6) for maturing a ruminant calf into an adult having an improved health status, 6) for maturing a ruminant calf into an adult having a more productive status, and 8) for reducing morbidity or mortality of a ruminant calf (e.g., dairy calf, beef calf), and other advantages.

### BACKGROUND

Ruminants (e.g., dairy cattle, beef cattle, sheep, goats, buffalo, moose, elks, bison, giraffes, yak, deer, antelopes, and others) can be distinguished from non-ruminant animals (e.g., monogastric animals having a single stomach chamber such as pigs, dogs, cats, horses and others) by the presence of a four-chambered stomach comprising the rumen, the reticulum, the omasum, and the abomasum. Ruminants acquire nutrients from plant-based food through fermentation in a specialized stomach chamber (rumen) prior to digestion, principally through microbial actions. The process typically requires regurgitation of fermented ingesta (known as cud), and chewing it again. The process of re-chewing the cud to further break down plant matter and stimulate digestion is called ‘rumination’. The fermentation of feed material mostly takes place in the rumen. The rumen is populated by several phyla of microorganisms, which result in fermentation of feedstuffs.

In mature or adult ruminants, fermentation of feed in the rumen provides the majority of energy and protein to the ruminants. In contrast to mature ruminants, new born ruminants (e.g., dairy calves, beef claves) or young ruminants have a rumen that is substantially undeveloped and non-functional. Consequently, the abomasum (instead of the rumen) temporally serves the role of primary stomach compartment for digestion until maturation of the rumen is completed later in life. For this reason, new born ruminants or young ruminants (e.g., dairy calves) are often referred to as “pseudo-monogastric animals” because the four-compartment stomach, although anatomically present, temporally behaves like a monogastric system.

Newborn or young ruminants (e.g., dairy calves) raised in commercial operations (e.g., dairy farms) are typically fed a liquid diet containing readily digestible nutrients (e.g., milk replacer). Such liquid diet typically consists of milk replacer, although often maternal milk (e.g., cow milk) may also be provided as the primary source of milk or as a complement to milk replacer, depending on the farm.

The natural weaning process, i.e., the transition from maternal milk and/or milk replacer to solid feed, occurs gradually and is usually completed at approximately 10 months of age (Reinhardt and Reinhardt, 1981). Adequate rumen development is essential for a successful weaning process, i.e., a process that yields young ruminants that are healthy (e.g., free of diseases such as infection) and meet expectations in terms of development, body weight, height, feeding behaviour, etc.). When a ruminant calf begins to eat solid feeds (e.g., starter feed rich in fermentable feed ingredients such as grains or cereals, by-products, molasses, fibers, etc.), the bacteria in the rumen begin to grow, which in turn initiate the production of ruminal fermentation products in the rumen. Fermentation of the fermentable feed ingredients (e.g., starch component of grains), results in the production of volatile fatty acids such as butyrate, which stimulates growth of rumen structures (e.g., papillae). After about 5 to 8 weeks of eating solid feed comprising fermentable feed ingredients (e.g., grains), the calf's rumen will be enriched with sufficient amount of microbes capable of fermenting feed (e.g., grains) and capable of supplying a substantial amount of energy. The rumen microbes also contribute microbial proteins, which constitute an important source of nutrition for ruminants. In other words, it takes time to morphologically and functionally develop the rumen from the time that solid feed comprising fermentable ingredients (e.g., grains) is introduced in the diet. The development time is about 5-12 weeks from when solid feed comprising fermentable feed ingredients (e.g., grains) is first fed, regardless of the age of the ruminant calf when first fed solid feed.

Therefore, because calves having adequate or sufficient rumen development can be triggered by feeding solid feed comprising fermentable ingredients for a period of about 5-12 weeks, it is generally accepted that calves can be physiologically ready for weaning as early as 5-12 weeks of age. Weaning may also start earlier, for instance, from birth or at 1 week or 2 weeks or 3 weeks or 4 weeks of age. In such instance, maturation of the rumen may take longer.

This notion has led to the development of several weaning strategies, also known as “early weaning strategies”. The development of early weaning strategies represents a major focus of interest in commercial operations, e.g., dairy production systems, in view of the economic incentives to transition calves from maternal milk and/or milk replacer to solid feed (also known as starter feed) as early as possible to reduce age at weaning, save money and time spent on calves, and spare maternal milk (e.g., cow milk) for human consumption.

One example of early weaning strategy consists of providing free-choice water and quality solid feeds to the ruminant calf in the first few days after birth, in addition to maternal milk and/or milk replacer. With this feeding strategy, by 5 to 12 weeks of age, the calf's rumen can be sufficiently developed and ready for the transition to a diet of solid feeds only (where milk or liquid supply is withdrawn). Therefore, the sooner fermentable feed ingredients (e.g., starch derived from grains) are digested by the calf (e.g., dairy calf and beef calf), the sooner rumen development occurs. When early weaning age is desired (e.g., 5 weeks of age or earlier, for example, from birth), it is important for the farmers to create conditions to facilitate the calf in eating the solid feed comprising fermentable feed ingredients (e.g., grains). However, the success of early weaning strategy highly depends on the calf's willingness to ingest solid feed (e.g., grains), which is not easy to achieve naturally. Often, ruminant calves need to be (at least partially) feed-deprived for the liquid diet (e.g., maternal milk and/or milk replacer) in order to entice them to ingest to solid feed (grains). In other words, ruminant calves (e.g., dairy calves) are not fed maternal milk and/or milk replacer ad libitum so as to purposely limit liquid intake and cause them to be hungry and eat solid feed. Overall, such strategy is not optimal because total intake will be diminished. Further, such weaning strategy may also cause high levels of stress to the ruminant calves, which in turn may lead to reduced weight gain and other detrimental effects on development, health status (disease) and/or later life performance (e.g., milk production, calving, meat production, etc.).

For decades, farmers have been focusing on a weaning strategy consisting of weaning ruminant calves at a very early age, i.e., weaning at about 4 weeks of age or earlier. Such a strategy was meant to stimulate earlier rumen development and to reduce rearing costs. However, more recent scientific studies have shown that such weaning strategies in early life have detrimental long-term consequences. Other studies have shown that ruminant calves benefit from having higher growth performance in the first 6-8 weeks of life results. Examples of benefits include greater lifetime milk production (Soberon et al., 2012) and as well as positive consequences for health and organ development. It was found that in order to reach higher rate of growth and development in early life, ruminant calves had to be fed a diet that mainly consists of milk and/or milk replacer. In other words, a higher rate of growth and development is realized by allowing ruminant calves to have a high milk and/or milk replacer intake in early life.

Ruminant calves reared according to this method had greater weight gain and improved somatic growth as well as reduced stress and improved health status (e.g., disease free). As a results, such program has become increasingly more popular in industry because promoting better growth (e.g., higher weight gain and somatic growth) and health status in early life has been shown to be beneficial later in life with respect to outcomes such as better health, growth rates, feed efficiency, and lifetime milk or meat production (Soberon et al., 2012). However, such program is associated with certain disadvantages. For instance, providing greater milk supply in early life is not only time-consuming and expensive but it also delays solid feed intake, which in turns delays rumen development and weaning age. Calves reared according this system experience stress during the weaning period (transition from milk to solid feed only), e.g., refusal to eat solid food, physical and emotional distress caused by maternal separation, reduced ability to digest solid feed, etc., which may lead to weight loss and decreased somatic growth (also known as weaning dip), and further delays in rumen development, and other detrimental effects such as susceptibility to diseases (e.g., infection).

In an attempt to minimize weaning stress or weaning dip, the industry has opted for different weaning strategies, where calves are weaned at a later age and in a more gradual fashion. An example of a commonly used strategy consists of weaning ruminant calves at around 7 weeks of age where milk intake is restricted in a step-down manner (i.e., gradually decreased) over the course of a period of about 2 to 3 weeks. However, such strategy only mitigates to some extent the same limitations as discussed above.

U.S. Pat. No. 4,600,585 describes a method for treating bovine to minimize and/or eliminate shock due to weaning from a fluid milk diet. Palatable solid milk replacer pellets were fed together with liquid milk material, and subsequently liquid milk material was eliminated, thereby starting the weaning process, and from then onwards solid milk replacer pellets were fed together with grains. The solid milk replacer pellets, which do not bypass the rumen by the oesophageal groove just like any other solid feed, would drop into the rumen and cause fermentation in the rumen thereby stimulating development of the rumen. However, introduction of even relatively modest quantities of fat into the rumen, and particularly the amounts mentioned in this US patent, will interfere with fibre accessibility in the rumen sufficiently to prevent access by the microbes necessary for fibre breakdown. The result of adding non rumen stable fat to the rumen is generally sub-optimal fermentation, and reduced energy supply. Moreover, high quality milk protein ferments to ammonia in the rumen losing their high nutritional value. Similarly, sugars (mainly lactose) ferment to volatile fatty acids in the rumen, and lose their glucose value. Furthermore, solid milk replacer pellets are not physically stable, and therefore have a low pellet durability index. They also comprise highly expensive raw materials that are greatly underutilised if they undergo ruminal fermentation.

Therefore, there is a need for alternative or improved weaning strategies or methods for ruminant calves (e.g., dairy calves) that: 1) reduce or prevent one or more of the limitations above and/or 2) reduce or abolish weaning stress (or weaning dip), and/or 3) reduce or prevent body weight loss and/or decreased height and/or increase body weight gain and/or increase somatic growth (e.g., height), and/or 4) increase solid feed intake and/or willingness to voluntarily eat solid feed, and/or 5) favour or increase maturation of the rumen, 6) improve the gut health and/or the gastrointestinal function of a ruminant calf, 7) promote maturation of a ruminant calf into an adult having an improved health status, 8) promote maturation of a ruminant calf into an adult having a more productive status and/or 9) reduce or prevent morbidity or mortality (e.g., as caused by diseases such as infections), and other advantages. There is also a need to develop solid feed compositions (e.g., pellets), which are suitable for use during and/or after the weaning process or in weaning methods and/or post-weaning methods, which not only provide the advantages desired in a weaning program and/or post-weaning program (as described above), but that also have high palatability as well as adequate physical integrity in terms of hardness and durability.

### BRIEF SUMMARY

In a first aspect, the present teaching relates to a solid feed combination for a ruminant calf comprising at least a first solid feed composition in the form of a pellet (e.g., an extruded pellet) and a second solid feed composition, wherein the first composition comprises between 20 wt. % and 90 wt. % of fat and one or more fermentable feed ingredients, and wherein the second composition comprises one or more fermentable feed ingredients, and wherein the total fat content of the solid feed combination is in the range of 5-20 wt. %.

In an aspect, the present teaching relates to a method for feeding a ruminant calf, comprising administering to the ruminant calf a solid feed combination, the combination comprising at least a first solid feed composition and a second solid feed composition, wherein the first solid feed composition is in the form of a pellet comprising between 20 wt. % and 90 wt. % of fat and one or more fermentable feed ingredients selected from starch, sugars, and fibers, and wherein the second solid feed composition comprises one or more fermentable feed ingredients, the second solid feed composition being in the form of a pellet, meal, muesli, or grains, and wherein the total fat content of the solid feed combination is in the range of 5-20 wt. %.

In an embodiment, the second solid feed composition comprises at most 5 wt. % of fat.

In an embodiment, the solid feed combination as taught herein may comprise one or more additional separate solid feed compositions comprising one or more fermentable feed ingredients.

In an embodiment, the fat comprised in the first solid composition comprises or consists of a rumen inert fat.

In an embodiment, the rumen inert fat may be selected from the group consisting of partially or fully hydrogenated fatty acids, and partially or fully hydrogenated fats.

In an embodiment, the one or more fermentable feed ingredients comprise fermentable carbohydrates.

In an embodiment, the fermentable carbohydrates include starch, sugars and fibres.

In an embodiment, the solid feed combination comprises or consists of a mixture of the first solid feed composition and the second solid feed combination.

In an embodiment, the first solid feed composition and the second solid feed composition may comprise substantially the same fermentable feed ingredients.

In an embodiment, the first solid feed composition and the second solid feed composition may comprise substantially different fermentable feed ingredients.

In an embodiment, the second solid feed composition is in the form of a pellet. However, the second solid feed composition does not need to be in the form of a pellet, e.g., the second solid feed composition may be any solid feed composition, for instance, meals, muesli, cereals and the likes, or any mixture thereof, etc.

In an embodiment, both the first solid feed composition and the second solid feed composition may be in the form of a pellet, preferably wherein the pellets are substantially the same size.

In a preferred embodiment, the first composition is in the form of an extruded pellet.

In an embodiment, the first solid feed composition is prepared by extruding the fermentable feed ingredients to obtain an extruded pellet, and vacuum coating the extruded pellet using the fat.

In an embodiment, the solid feed combination is a mixture with a fixed ratio of the first solid feed composition relative to the second solid feed composition.

In an embodiment, the first solid feed composition is not a fat prill, e.g., a prill comprising more than 95% by weight of fat, for instance, hydrogenated fat such as hydrogenated palm oil.

In an embodiment, the first solid feed composition does not comprise, or consist of, a saponified fat, such as a calcium soap of an oil.

In an embodiment, the ratio of the first solid feed composition relative to the second solid feed compositions is between 30:70 and 1:99.

In an embodiment, the ruminant calf may be selected from the group of dairy calf, beef calf, veal calf, sheep lamb, goat kid, buffalo calf, moose calf, elk calf, bison calf, giraffe calf, yak calf, deer calf, antelope calf, preferably a dairy or a beef calf.

In an embodiment, the solid feed combination is administered during weaning of the ruminant calf.

In a second aspect, this disclosure relates to a method for reducing weaning stress of a ruminant calf during and/or after the weaning period, the method comprising the step of feeding to the ruminant calf the solid feed combination as taught herein during and/or after the weaning period.

In a further aspect, this disclosure relates to a method for preventing a decrease in somatic growth due to weaning of a ruminant calf during and/or after the weaning period, the method comprising the step of feeding to the ruminant calf the solid feed combination as taught herein during and/or after the weaning period.

In a further aspect, this disclosure relates to method for reducing morbidity and/or mortality of a ruminant calf during and/or after the weaning period, the method comprising the step of feeding to the ruminant calf the solid feed combination as taught herein during and/or after the weaning period.

In a further aspect, this disclosure relates to a method for increasing solid feed intake of a ruminant calf during the weaning period and/or after, the method comprising the step of feeding to the ruminant calf the solid feed combination as taught herein during and/or after the weaning period.

In a further aspect, this disclosure relates to a method for developing and maturing the rumen of a ruminant calf during and/or after the weaning period, the method comprising the step of feeding to the ruminant calf the solid feed combination as taught herein during and/or after the weaning period.

In a further aspect, this disclosure relates to a method for maturing a ruminant calf into an adult having an improved health status, the method comprising the step of feeding to the ruminant calf the solid feed combination as taught herein during and/or after the weaning period.

In a further aspect, this disclosure relates to a method for maturing a ruminant calf into an adult having a more productive status, the method comprising the step of feeding to the ruminant calf the solid feed combination as taught herein during and/or after the weaning period.

In a further aspect, this disclosure relates to a method for improving gut health and/or gastrointestinal function of a ruminant calf, the method comprising the step of feeding to the ruminant calf the solid feed combination as taught herein during and/or after the weaning period.

In an embodiment relating to any of the methods as taught herein, the ruminant calf is fed the solid feed combination as taught herein for at least about 1 week, e.g., at least about 1 week, about 2 weeks, 3 weeks about 3 weeks, about 4 weeks, about 5 weeks, about 6 weeks, about 7 weeks, about 8 weeks, about 9 weeks, about 10 weeks, or more.

In an embodiment relating to any of the methods as taught herein, the solid feed combination, according to this disclosure, may be fed ad libitum to the ruminant calf.

In an embodiment relating to any of the methods as taught herein, the ruminant calf may be selected from the group of dairy calf, beef calf, veal calf, sheep lamb, goat kid, buffalo calf, moose calf, elk calf, bison calf, giraffe calf, yak calf, deer calf, antelope calf, preferably a dairy calf or a beef calf.

### BRIEF DESCRIPTION OF THE DRAWINGS

FIG. 1 depicts the effects of various starter diets on the average daily gain (grams/day) in the weaning period (period spanning from 0-8 weeks from birth).

FIG. 2 depicts the effects of various starter diets on the average daily gain (grams/day) in the post-weaning period (period spanning from weeks 8-12 from birth).

FIG. 3 depicts the effects of various starter diets on solid feed intake (grams/day) in the weaning period (period spanning from 0-8 weeks from birth).

FIG. 4 depicts the effects of various starter diets on solid feed intake (grams/day) in the post-weaning period (period spanning from weeks 8-12 from birth).

### DETAILED DESCRIPTION

### Definitions

The term “calf” (plural, calves) as used herein refers to young domestic animals such as, for example, a dairy, beef, veal, sheep, goats, buffalo, moose, elks, bison, giraffes, yak, deer, or antelope cattle and others). The term “calf” is the term used from birth to weaning, a time at which the calf becomes known as a weaner or weaner calf, though in some areas the term “calf” may be used until the animal is a yearling (i.e., an animal that is between one and two years old). The birth of a calf is known as calving. A young female calf from birth until she has had a calf of her own is known as a heifer. Bovine calves are naturally weaned at about eight to ten months of age, depending on the species. Further, depending on the season, health status and/or calf rearing system (e.g., weaning programs) employed on a given farm, the calves may be weaned earlier than the natural weaning age, for instance, at 5-12 weeks of age. Calves (e.g., dairy calves, beef calves) may also be weaned at an earlier age, e.g., at birth or at 1 week of age or 2 weeks of age or 3 weeks of age or 4 weeks of age. In the context of this disclosure, the term “calf” refers to a ruminant calf, for instance, dairy calf, beef calf, veal calf, sheep lamb, goat kid, buffalo calf, moose calf, elk calf, bison calf, giraffe calf, yak calf, deer calf, antelope calf, preferably a dairy calf or a beef calf.

The term “starter feed composition” (also known as rumen starter feed composition) as used herein refers to any solid/dry feed compositions suitable for a ruminant calf that is being fully or partially weaned from milk replacer and/or maternal milk. Starter feed compositions comprise feed ingredients that are fermentable in the rumen. Typically, feed ingredients comprising fermentable carbohydrates form the basis of starter feed composition. Rumen fermentable carbohydrates are important to optimize rumen microbial growth and fermentation, maintain microbial amino acid production and energy as volatile fatty acids. Non-limiting examples of rumen fermentable carbohydrates suitable for starter feed compositions include starch (e.g., as found in grains or cereals such as barley, corn, sorghum, wheat, oat, rye, and the like.), sugar (e.g., molasses, lactose, dextrose, sucrose, glucose, fructose, galactose, xylose, arabinose, beta-glucans, galactans, pectins, and the like), fermentable fibers (e.g., as found in forages such as straw, alfalfa and/or grasses, in hay, haylage, silage or pellet form, and the like or by-products such as beet pulp, citrus pulp, soy hulls and the like), as well as any mixture thereof. Starter feed compositions also comprise proteins (e.g., soybean, various proteins contained in grains or cereals), other nutrients such as vitamins and minerals as well as medicine (e.g., antibiotics). A great variety of starter feed compositions suitable for ruminant calves are commercially available (e.g., Milki Apetito, Josera Kalberkost) and exists in several forms, including meals, pellets and multiple component mixtures such as muesli's. The skilled person is well-acquainted with the term “starter feed composition” for ruminant calves and knows how to select a starter feed composition suitable for ruminant calves (e.g., dairy calves), depending on the type of ruminant calves, weaning strategy, age at weaning, health status etc. Ruminant calves are typically allowed to eat solid starter feed composition at ad libitum. The rate of ingestion of a given starter feed composition is generally low at the onset of the weaning process and gradually increases through weaning process as the animal naturally transitions from an all liquid diet to a solid diet only. Therefore, characteristics of the starter feed composition such as palatability, hardness of the feed (e.g., pellet), digestibility, nutritional value or ability to gain access to the starter feed composition are important factors to consider when choosing a starter feed composition for a given ruminant calf.

The term “milk replacer” as used herein refers to any conventional milk replacers suitable for ruminant calves (e.g., dairy calves). Typically, milk replacers contain less than 30 percent protein by dry weight (although in some instances, they may contain more), less than 25% fat, and about 35 to 50% lactose and are fed in conventional settings, e.g., at a rate of up to about 1.2 kg per head/day on a dry weight basis. Most conventional milk replacers contain milk proteins that are typically derived from cow's milk. Some conventional milk replacers may contain non-milk proteins from other sources as well as other nutritional ingredients, lactose, fat, vitamins, minerals, and/or medicine (e.g., antibiotics). A variety of milk replacers are commercially available on the market (e.g., Sprayfo Excellent, Denkamilk Royal). The skilled person is well-acquainted with milk replacers and can readily select a suitable milk replacer for a ruminant calf depending on the farming practice, weaning strategy, age of the calf, health status of the calf, etc.

The term “weaning” as used herein refers to the process of introducing a ruminant calf (e.g., dairy calf, beef calf) to what will be its adult diet and withdrawing the supply of its mother's milk and/or milk replacer. In other words, weaning essentially consists of a transition from milk only (e.g., milk replacer or maternal milk) to solid feed only. The transition from milk only to solid feed only may be performed gradually over time e.g., milk supply is gradually decreased while solid feed is gradually introduced) or may be performed suddenly (i.e., when milk supply is completely withdrawn and diet consists of solid feed only).

The term “weaning period” as used herein refers to the period of time needed to complete the transition from milk only (e.g., milk replacer or maternal milk) to solid feed only. For instance, when the transition from milk to solid feed is performed gradually (e.g., milk supply is gradually decreased and solid feed is gradually introduced), the weaning period will encompass the time spanning from the onset of introducing solid feed, until the moment (time) when weaning is completed, i.e., when milk supply is completely withdrawn and diet consists of solid feed only.

For instance, considering that it takes on average about 8 weeks to develop the rumen from the initial time a solid diet rich in fermentable carbohydrate and/or proteins (e.g., grains) is fed to the ruminant calf the weaning period may last about 5-10 weeks or longer, e.g., at least about 5 weeks, about 6 weeks, 7 weeks, 8 weeks, 9 weeks, 10 weeks or longer. In certain situations, the weaning period may be shorter, e.g., 1-2 days up to 10 weeks or more such as 1-2 days, 5 days, 10 days, 15 days, 20 days, 25 days, 30 days, 40 days, 50 days, 60 days, 70 days, 80 days, 90 days, 100 days, 110 days, 120 days, 130 days, 140 days, 150 days, 160 days, 170 days, 180 days, 190 days, 200 days, 250 days, 300 days or more.

In an embodiment relating to any of the methods as taught herein, the weaning period may last until the time where milk replacer or maternal milk is completely withdrawn from the ruminant calf and replaced by a diet consisting of solid feed only. As explained herein, it is understood that the weaning process may begin when milk or milk replacer is still supplied to the ruminant calf (albeit gradually reduced) and solid feed is gradually supplied next to milk or milk replacer. This can be at various time points during early life of the ruminant calf, depending on the weaning strategy employed (e.g., at 5-12 weeks of age or earlier). In other words, the ruminant calf may be weaned at any age and thus may be fed the combination composition as taught herein during the weaning period irrespective of its age. For instance, the ruminant calf (e.g., dairy calf or beef calf) may be weaned starting at birth, i.e., solid food is introduced in the diet together with milk replacer, and may be fed the combination composition as taught herein from the age of 0 to 4 months from birth. In that case the weaning period would last 4 months.

Depending on the farming system, commercial operations, etc., weaning in cattle (e.g., dairy calves) can be done according to different methods. Dairy calves are usually separated from their mother at birth in most dairy operations. Dairy calves are generally weaned at the age of 5-10 weeks, in order to allow greater milk supply in early life for the purpose of boosting growth and health in early life, as explained above.

The main purpose of separating dairy cows from their calves as early as possible is to allow collection of maternal milk and selling it for human consumption. The calves are then fed colostrum from the mother for the first few days, and then milk replacer is introduced. Dairy calves do not usually have ad libitum access to milk like suckling beef calves. In some commercial operations, beef calves (e.g., veal calves) may be separated from their mother at birth and fed maternal and milk replacer like dairy calves. By limiting the amount of milk the calves (e.g., dairy calves, veal calves) receive (e.g., to induce hunger), it caused the calves to consume more solid feed, which usually leads to faster development of the rumen.

It is understood that the weaning age of ruminant calf (i.e., age at which the weaning process is finalized, i.e., ruminant eats solid feed only and milk supply is completely withdrawn) will depend on the weaning strategy employed in a farm or commercial operation, type of ruminant calf, the health status of the calf, etc.

The term “post-weaning” or “post-weaning period” as used herein refers to a period of time taking place after weaning has been completed, i.e., when the milk supply is completely withdrawn and the diet consists of solid feed only. It is understood that the age of a ruminant calf during the post-weaning period (i.e., age at which the weaning process is finalized, i.e., ruminant eats solid feed only and milk supply is completely withdrawn) will depend on the weaning strategy employed in a farm or commercial operation, type of ruminant calf, the health status of the calf, etc.

The term “weaning stress” as used herein refers to any stress experienced by a ruminant calf during and/or after the weaning period. For instance, weaning stress may include emotional stress and physiological stress caused by transitioning a ruminant calf from milk or liquid diet to solid feed diet. Specifically, weaning stress may be manifested in the form of e.g., reduced ability to digest and consume solid feed, digestive problems causing pain, intestinal tract problems such as increased gut permeability (e.g., leaky gut), diarrhea or other infections, body weight loss, somatic growth loss (e.g., height), energy deficits (due to insufficient nutrition), delays in rumen development or maturation and others. Any of the consequences of weaning stress, e.g., on body weight, somatic growth, health, solid feed intake, etc may also be referred to as “weaning dip”.

The term “rumen development” as used herein refers to a developmental process taking place in the rumen of a ruminant calf in early life. Ruminant calves (e.g., dairy calves) are born with a four-chambered stomach comprising the rumen, the reticulum, the omasum and the abomasum, just like in adult ruminants. However, in contrast to adult ruminants, ruminant calves (e.g., dairy calves) are born with an undeveloped and non-functional rumen. Further, the relative proportion of each stomach compartment differs in a ruminant calf compared to an adult ruminant, as shown in Table A below.

TABLE A
Relative size (% of the whole stomach) of the stomach compartments
in a new born ruminant calf (e.g., dairy calf, beef calf) compared
to an adult or mature ruminant (e.g., dairy cow).

| Ruminant | Rumen | Reticulum | Omasum | Abomasum |
|---|---|---|---|---|
| (life stage) | (%) | (%) | (%) | (%) |
| Newborn ruminant | 25 | 5 | 10 | 60 |
| Adult or mature | 80 | 5 | 8 | 7 |

Before the rumen develops, milk (e.g., maternal milk or milk replacer) flows directly to the abomasum via the oesophageal groove (a fold in the alimentary tract, which directs liquids to the abomasum), therefore bypassing the rumen, reticulum and omasum. During this period, the abomasum serves the function of primary stomach compartment for digestion and nutrient assimilation until maturation of the rumen is completed later in life. For this reason, ruminant calves are often referred to as “pseudo-monogastric animals” or “pre-ruminant” because the four-compartment stomach, although anatomically present, behaves (temporarily) like a monogastric system.

Under natural weaning conditions (e.g., occurring around 8-10 months of age), digestive enzyme changes (as well as other changes such as development of anatomical structures in the rumen (e.g., papillae) and colonization of the rumen by microorganisms capable of fermenting feeds) coupled to the high energy costs of maintaining a pre-weaned calf facilitate the ability and prompt the need to transition the calf from “pseudo-monogastric” animal to a ruminant animal. However, in most commercial operations or farms, maturation or development of the rumen is purposely manipulated by the use of a specific feeding management (e.g., what is fed, when, how much) and nutrition (particular type of feed, e.g., milk and/or grains).

Manipulation of the feeding management and nutrition can be performed during the weaning period (i.e., before complete withdrawal of milk and transition to solid/dry feed only) where milk supply is not withdrawn or not completely withdrawn yet while solid/dry feed is introduced at the same time in the diet. This is typically done for the purpose weaning calves at an earlier age (e.g., 5-10 weeks of age or earlier, as indicated above).

Strategies for influencing rumen development or maturation by manipulating feeding management and nutrition mainly rely on the use of solid feed comprising fermentable feed ingredients (e.g., starch derived from grains). That is because solid feed comprising fermentable feed ingredients stimulates rumen microbial proliferation and production of microbial end products, volatile fatty acids, which have been shown to initiate rumen epithelial development. It is generally believed that a period of about 7 weeks is needed to fully develop the rumen from the initial time that solid feed comprising fermentable ingredients (e.g., grains) is fed, regardless of the age at which the ruminant is fed solid feed for the first time.

Therefore, when early weaning age is desired (e.g., 5-12 weeks of age or earlier as indicated above), it is important for the farmers to create the conditions to facilitate consumption of solid feed comprising fermentable feed ingredients. However, this is not always easy to achieve since besides having reduced capacity to digest solid feeds, calves tend to prefer milk over solid feeds and thus may not be willing to eat solid feed unless they are (partially) feed-deprived. The success of early weaning strategy highly depends on the calf's willingness to ingest solid feed (e.g., grains), which is not easy to achieve naturally. This is not optimal since such weaning strategies are not only time consuming for the farmers but they may also cause high levels of stress to the ruminant calves, which in turn may lead to weight loss and other detrimental effects on growth (reduced height), health status (susceptibility to diseases such as infections) and/or later life performance (e.g., reduced milk production, reduced meat production, etc.).

When greater milk supply is desired for the purpose of boosting growth and health of the ruminant calf in early life, manipulation of feeding management and nutrition using solid feed is also crucial to help minimizing the impact of weaning stress (i.e., any stress experienced during the transition from milk only to solid feed only). In such situation, the ruminant calves experience stress (or weaning dip) during the weaning period (transition from milk to solid feed only), which leads to refusal to eat solid food, physical and emotional distress caused by maternal separation, reduced ability to digest solid feed, etc. Globally this lead to weight loss, decreased somatic growth (e.g., decreased height gains), decreased health (greater susceptibility to diseases such as infections, leaky gut, etc.), further delays in rumen development as well as decreased later life performances (e.g., milk production, meat production, etc.).

In other words, the time it takes for a ruminant calf to change from using just the abomasum to efficiently using all four stomachs depends on the type of feed the calf is given and how feeding management is performed. If milk is freely available or provided at a high level (e.g., when greater milk supply is desired in early like to boost growth and health, as explained above), the calf will have only a small appetite for solid/dry feeds and stomach (rumen) development will be slow. This pre-ruminant phase is most critical (i.e., stressful) in the calfs development. For instance, because calves have reduced ability to digest solid feed, even the smallest digestive upsets can lead to scours (diarrhoea), then dehydration, weight loss, reduced growth (e.g., height), susceptibility to diseases (e.g., infections), reduced heath (e.g., leaky gut), etc., which globally threaten survival or long-term performance (e.g., milk production or meat production later in life). Conversely, if feeding management encourages the calf to eat solid/dry feeds comprising fermentable feed ingredients (e.g., grains) as early as possible (e.g., from 1 week of age), it will help promote rumen development, reduce dependence on liquid milk and will facilitate the weaning process. However, it is notoriously difficult to entice calves to eat solid feed at such early age without feed-depriving them (e.g., restricting milk supply). This also causes stress, which may lead to weight loss, reduced growth (e.g., height), susceptibility to diseases (e.g., infections), reduced health (e.g., leaky gut), and other detrimental effects.

Therefore, solid feed compositions are central to successful weaning and/or post-weaning strategies. An ideal solid feed composition for a ruminant calf (e.g., dairy calf, beef calf) for use in weaning and/or post-weaning strategies, should allow for a smooth or smoother transition from a pseudo-monogastric state (undeveloped rumen) to an adult-like or mature ruminant status developed rumen), i.e., with minimal weight loss, minimal loss in growth (e.g., height), minimal deterioration of health (reduced susceptibility to diseases such as infection, preventing leaky gut) by favouring adequate maturation or development of the rumen for efficient utilization (e.g., fermentation) of solid/dry feed and forage-based diet and by providing sufficient energy to counteract or minimize the impact of weaning stress on body weight loss or somatic growth loss (e.g., height), regardless of the age at which the ruminant calf is weaned or fed solid feed for the first time. The solid feed combination as taught herein is suitable to achieve these purposes.

The term ‘about’, as used herein indicates a range of normal tolerance in the art, for example, within 2 standard deviations of the mean. The term “about” can be understood as encompassing values that deviate at most 10%, 9%, 8%, 7%, 6%, 5%, 4%, 3%, 2%, 1%, 0.5%, 0.1%, 0.05%, or 0.01% of the indicated value.

The terms ‘comprising’ or ‘to comprise’ and their conjugations, as used herein, refer to a situation wherein the terms are used in their non-limiting sense to mean that items following the word are included, but items not specifically mentioned are not excluded. It also encompasses the more limiting verbs ‘to consist essentially of’ and ‘to consist of’.

Reference to an element by the indefinite article ‘a’ or ‘an’ does not exclude the possibility that more than one of the elements is present, unless the context clearly requires that there be one and only one of the elements. The indefinite article ‘a’ or ‘an’ thus usually means ‘at least one’.

The terms ‘to increase’, ‘to decrease’ or ‘to improve’, as taught herein, refer to the ability to significantly increase or significantly decrease or significantly improve an outcome. Generally, a parameter is increased or decreased or improved when it is at least 5%, such as 10%, 15%, 20%, 25%, 30%, 35%, 40%, 45%, 50% higher or lower or improved, respectively, than the corresponding value in a control. In the context of this disclosure, the control may be a ruminant calf, which did not receive the solid feed combination as taught herein during the weaning period. When comparing whether or not any of the parameters taught herein are increased or decreased or improved, the test ruminant and the control are preferably of the same genus and/or species and/or age (e.g., test and control are both dairy calves of the same age).

The term “pellets” or “feed pellets” as used herein refers to small particles or a body typically created by compressing an original material, for instance, a mixture of raw feed material, typically fermentable feed ingredients such as grains, cereals, legumes, roughage, and the likes. Feed pellets may also comprise other feed ingredients such as meat meal, fish meal, bone meal, by-process products, oil, fat, fillers or any mixture thereof, etc., as well as minerals, vitamins and trace elements and others. Animal feed pellets vary in their composition as well as structural properties (e.g., hardness, density, durability, shape, size, etc.) depending on the nutritional needs, eating habits, digestive system (monogastric system, ruminant digestive system, etc.) and habitat (e.g., aquatic, terrestrial, domestic, etc.) of the animal for which the feed pellet is intended. Animal feed pellet may have any size, shape (e.g., round, rectangular, cylindrical, etc), weight and/or length. It is understood that the weight of the feed pellet will depend on the feed pellet composition per se (e.g., some ingredients have a greater weight or density than others) as well as the shape, size and length of the finished feed pellet product. It is known that the size, shape, weight and/or length of the feed pellet will influence pellet durability. This is true for any method for making feed pellets, including method as taught herein. It is further commonly agreed in the field of agriculture and animal nutrition that animals (e.g., young and adult livestock animals like beef (e.g., beef calf), dairy cows (e.g., dairy calf), and pigs, etc.) benefit more or make better gains (e.g., weight gain, increased height, enhanced growth curve) on pelleted feed than a meal ration because pelleted feed is in a more concentrated, readily edible and palatable form than meal or mash ration. Pelleted feed has been shown to ease food intake and minimize feed waste during the eating process. It was shown that most animals, if given the choice between the same feed in a pellet or a mash form, will prefer the pellet form. Animal feed pellets are typically produced on an industrial scale using, for example, a pelleting process. The skilled person is well-acquainted with processes for producing animal feed pellets.

It is understood that the term “pellets” or “feed pellets” is distinct from the term “prill” or “fat prill”. For instance, the skilled person understands that a fat prill made of more than 95 wt. % of fat, e.g., hydrogenated fat such as hydrogenated palm oil, is not a pellet (particularly not an extruded pellet) according to this disclosure. The term “prill” or “fat prill” as used herein refers to a small aggregate or globule of a material formed from a melted liquid (e.g., fat such as palm oil) and devoid of solid raw feed material such as fermentable feed ingredients (e.g., grains, cereals, legumes, roughage, and the likes) as well as other solid feed ingredients (e.g., meat meal, fish meal, bone meal, etc.). The material to be prilled must be in a solid state at room temperature and must be a low-viscosity liquid when melted. Prills are typically formed by allowing drops of the melted prill substance to congeal or freeze in mid-air after being dripped from the top of a tall prilling tower.

Compositions

The present inventors have found a solution to minimize the impact of weaning stress in a ruminant calf (e.g., dairy calf, beef calf) during and/or after the weaning period. In other words, the present inventors have found a solution to alleviate or prevent: 1) reduced solid feed intake, 2) reduced energy status (e.g., not enough calories to sustain bodily needs or functions), 3) reduced body weight or reduced body weight gain, 4) reduced somatic growth (e.g., reduced height), 5) reduced or jeopardized health status (e.g., increased susceptibility to diseases such as infection or risk of dying), 6) reduced gastrointestinal damage or problems (e.g., leaky gut), and/or 7) reduced or delayed rumen development or maturation, which typically occur during and/or after the weaning period. Specifically, the present inventors have solved at least one of the problems mentioned above by providing the solid feed combination composition as taught herein, which can be used in any weaning and/or post-weaning programs for ruminant calves (e.g., dairy calves), regardless of the type of ruminant calf or the age of the calf at weaning or post-weaning.

Specifically, the solid feed combination composition taught herein comprises at least two distinct (separate physical entities) solid feed compositions (e.g., in the form of two separate feed pellets), which vary in their respective fat content. Specifically, one of the two solid feed compositions has a relatively high fat content (between 20 wt. % and 90 wt. % fat, wherein the fat may be a rumen inert fat (although not essential), i.e., a fat type that is not degradable or digestible in the rumen and does not interfere with the fermentation of other feed ingredients in the rumen and is in the form of a pellet (e.g., extruded pellet) comprising one or more fermentable feed ingredients (e.g., grains, cereals, molasses), while the other solid feed composition has a relatively low fat content (preferably less than 5 wt. %, wherein the fat does not have to be a rumen inert fat) while comprising fermentable feed ingredients such as grains, cereals, molasses, etc.

Further, the present inventors found that when the total fat content of the solid feed combination mixture of the disclosure (e.g., the two distinct solid feed composition fed together to a ruminant calf) is in the range of 5-20 wt. % (preferably 5-10 wt. %), several advantages are observed. Specifically, the present inventors have surprisingly found that feeding a ruminant calf (e.g., a dairy calf) with the solid feed combination composition as taught herein is particularly beneficial for preventing the above-mentioned issues as well as: 1) reducing weaning stress of a ruminant calf during and/or after the weaning period, 2) for increasing somatic growth (body weight and/or height) of a ruminant calf during and/or after the weaning period, 3) for decreasing morbidity and/or mortality (e.g., caused by diseases such as infection) of a ruminant calf during and/or after the weaning period, 4) for increasing solid feed intake of a ruminant calf during and/or after the weaning period, and 5) for maturing the rumen of a ruminant calf during and/or the weaning period, 6) for improving the gut health and/or the gastrointestinal function of a ruminant calf, 7) for maturing a ruminant calf into an adult having an improved health status, and/or 8) for maturing a ruminant calf into an adult having a more productive status, and other advantages.

Without wishing to be bound to any theories, it is believed that the beneficial effects conferred by the solid feed combination composition of the disclosure may be explained, at least in part, by the provision of higher fat level, in addition to fermentable solid feed ingredients (e.g., grains, cereals, etc.), during the weaning period than would normally be possible with traditional solid feed compositions. By providing more fat in combination to providing fermentable feed ingredients during the weaning and/or post-weaning period, a higher energy status is achieved in the ruminant calf, which contributes to alleviate or prevent the negative impact of weaning and/or post-weaning on somatic growth (e.g., decreased in body weight and/or height), feed intake, rumen development or maturation, health status (e.g., susceptibility to diseases such as infections) and other aspects of ruminant calf physiology (e.g., later life performances such as milk production, meat production and reproduction). In sum, it is believed that the solid feed combination composition of the disclosure promotes maximum intake of fermentable feed ingredients (e.g., grains) while allowing for an additional intake of energy from the non-fermentable fraction of the solid feed combination composition (i.e., fat content).

The solid feed combination composition of the disclosure represents a major departure from traditional solid feed compositions (e.g., starter feed for ruminant calves) for the purpose of weaning ruminant calves and/or for supporting post-weaning adaptations to solid feed diet in ruminant calves (e.g., dairy calves, beef calves).

Traditional solid starter feed compositions typically contain less than 5 wt. % fat. The idea of feeding a solid feed composition comprising higher levels of fat (i.e., >5 wt. %) was not envisaged because, although fat was known as an energy rich nutrient, feeding high fat levels (>5% wt. %) to ruminant calves was not considered as a suitable option in the field of ruminant calf nutrition. Specifically, fat inclusion (beyond 5 wt. %) in solid feeds was regarded as detrimental or undesirable as fat is known to interfere with fermentation in the rumen. For instance, when fat and fermentable ingredients (e.g., grains or cereals) are combined in one pellet, fat physically covers fermentable components and limits bacterial access to fermentable fractions of the feed. This decreases the energetic value of the feed beyond what fat may bring to the diet because part of the feed (fermentable fraction) cannot be utilized (i.e., fermented by the rumen). Also, this delays rumen development and lowers feed intake and the energy status of the calf.

Another reason for not including fat in solid feed composition beyond 5 wt. % of the total feed composition is because it would compromise or affect pellet hardness and durability, i.e., the higher the levels of fats, the lower the durability or hardness (propensity to break or being too soft) of the pellet is. Such feed pellets are difficult to process during manufacturing and difficult to handle during transport, storage (e.g., in silos) as well as during use by customers. Globally, pellets with hardness and durability issues are perceived by the customers as having a low quality and therefore are not purchased.

Therefore, one of the focuses of interest in the field of ruminant calf nutrition at the time of filing of the present disclosure, was to develop solid feed compositions having proper physical characteristics in terms of hardness and durability and that are rich in fermentable feed ingredients (e.g., fermentable carbohydrates such as starch, e.g., derived from grains) and that have a low fat content (i.e., below 5 wt. %, typically 3 wt. %). Such solid feed compositions were believed to be optimal for promoting rumen fermentation of fermentable feed ingredients, which is necessary for proper rumen development during the weaning period. The present inventors have surprisingly found that solid feed compositions for ruminant calf need not having these properties for optimal effects on rumen development and for achieving a smooth transition from calf to adult during the weaning period and/or post-weaning period with minimal stress (or weaning dip), as will be shown herein.

In a first aspect, the present disclosure teaches a solid feed combination composition for administration to a ruminant calf comprising at least a first solid feed composition and a second solid feed composition, wherein the first composition is in the form of a pellet (e.g., an extruded pellet) and comprises at least 20 wt. %, such as between 20 and 90 wt. %, of fat and one or more fermentable feed ingredients, and wherein the second composition comprises one or more fermentable feed ingredients, and wherein the total fat content of the solid feed combination is in the range of 5-20 wt. %, such as, for instance, in the range of 6-18 wt. %, 7-16 wt. %, 8-15 wt. %, 9-14 wt. %, 10-12 wt. %, 5-10 wt. %, or 5-8 wt. %. It was found that when such fat content was included in the combination composition of the disclosure, greater body weight gain (Kg), greater solid feed intake (grams per day) as well as greater rumen development was achieved during the weaning period.

In an embodiment, the second solid feed composition comprises at most 5 wt. % fat. The fat comprised in the second solid feed composition may be any type of fat (e.g., rumen inert fat or non-rumen inert fat). For instance, the fat may be an integral constituent of the fermentable feed component, e.g., fat naturally contained in grains, cereals, etc. In other instances, the fat may be added to the second solid feed composition in an amount that does not exceed 5 wt. % of the total second solid feed composition, and that does not affect the physical integrity of the second solid feed composition in terms of hardness and durability. It may be advantageous to limit the fat content of the second solid feed composition to at most 5 wt. % of the whole second feed composition for the purpose of facilitating or promoting fermentation of the fermentable feed ingredients in the rumen.

The term “solid feed combination for administration to a ruminant calf” as used herein refers to a feed composition suitable for ingestion by a ruminant calf (e.g., dairy calf, beef calf), which is made of at least two separate components (i.e., distinct entities), for instance, two separate pellets comprising a different fat content and different fermentable feed ingredients. Alternatively, it may be two separate feed pellets comprising a different fat content and substantially the same or different fermentable feed ingredients. For instance, the first solid feed composition and the second solid feed compositions as taught above may be in the form of two different feed pellets, although that is not essential. For instance, the first solid feed composition is a pellet (e.g., an extruded pellet) comprising one or more fermentable feed ingredients (e.g., corn, oats, wheat, etc.), while the second solid feed composition may be a pellet, grains (e.g., corn, oats, wheat, etc.), a meal, a muesli, or any mixture thereof. Advantageously, the first solid feed composition, which is in the form of a pellet (e.g., an extruded pellet) and the second solid feed composition are in such form that they can be mixed homogeneously. It is further understood that the first and second solid compositions as taught above are to be fed to ruminant calf in combination, i.e., at the same time or during the same feeding event. Preferably, although not essential, that the first and second solid compositions as taught above are fed as a mixture, preferably mixed together in an homogenous manner, i.e., both the first and second solid feed compositions are not readily distinguishable by the ruminant calf (e.g., the calf will display no particular preference for one solid composition over the other, so that they will be both ingested) and/or will not easily separate (e.g., one of the two solid feed compositions sinking at the bottom leaving the other at the top).

In a preferred embodiment, the fat comprised in the first solid feed composition is a rumen inert fat. The term “inert fat” or “rumen inert fat” as used herein refers to fats or oils that are not transformed in the rumen and that do not impede fermentation of other feed (e.g., fermentable feed ingredients) in the rumen of a calf Rumen inert fats are also known as rumen “bypass”, “protected” or “escape” fats because they are not degraded, transformed or fermentable in the rumen. Non-limiting examples of inert fats suitable for the solid feed combination as taught herein include any partially or fully hydrogenated fatty acids, or partially or fully hydrogenated fats (e.g., hydrogenated tallow fat, hydrogenated vegetable oil (e.g., palm oil, rapeseed oil, soybean oil, etc.). Other examples of inert fat include fats that are physically protected or comprised within a given structure such as extruded oil seeds or whole oil seed, and the like. Such fats are considered inert because the fat or oil is not free to mix with other ingredients because it is comprised or trapped within a physical structure (e.g., seed). The skilled person is well-acquainted with the term rumen inert fat and knows how to select a suitable inert fat for the composition taught herein.

In an embodiment, the fat may be incorporated into the first solid feed composition, which is in the form of a pellet (e.g., an extruded pellet) comprising one or more fermentable feed ingredients using any suitable methods in the art allowing the inclusion of a relatively high amount of fat, preferably inert fat, (between 20 wt. % and 90 wt. %, e.g., between 25 wt. % and 90 wt. %, between 30 wt. % and 88 wt. %, between 35 wt. % and 85 wt. %, between 40 wt. % and 80 wt. %, e.g., 20 wt. %, 25 wt. %, 30 wt. %, 35 wt. %, 40 wt. %, 45 wt. %, 50 wt. %, 55 wt. %, 60 wt. %, 65 wt. %, 70 wt. %, or more) in a pellet without affecting its physical integrity in terms of hardness and durability. A non-limiting example of such method is the process of forming pellets using an extrusion process (e.g., to form extruded pellets) combined with vacuum coating technology.

With such vacuum coating technology, the feed pellets are first formed by a conventional extrusion process, and then treated with liquid fat under reduced pressure. This technology permits larger amounts of fat to be added, without destroying the integrity of the pellets. The process allows for control of the density of the pellets, independently of the composition and texture thereof, whilst allowing absorption of relatively large volumes of fats into the pellets.

Thus, in an embodiment, the first solid feed composition is prepared by treating extruded solid feed pellets with a controlled quantity of fat and subjecting the treated pellets to conditions of sub-atmospheric pressure to absorb the fat into the pellets, and recovering the pellets containing absorbed fat in solid, discrete form.

In such embodiment, the fat may largely cover the one or more fermentable feed ingredients. Thus, the fat may prevent the one or more fermentable feed ingredients from being fermented by the rumen microbes, which are not capable of degrading the fat. Only upon entering the gastrointestinal tract, the fat and consequently also the one or more fermentable feed ingredients are degraded into nutrients that can be absorbed along the intestinal wall.

In an embodiment, the first solid feed composition comprises at least 20 wt. %, such as between 20 and 90 wt. % of fat, such as, for instance, in the range of 20-90 wt. %, 25-88 wt. %, 30-80 wt. %, 35-70 wt. %, or 40-60 wt. %.

In an embodiment, a fat may be any fat, for instance, a fat that per se is not rumen inert (e.g., such as extruded oil seeds or whole oil seed or an oil that is physically protected or trapped within the physical structure of an extruded pellet). Such fat may, nevertheless, become rumen inert when the fat is comprised or trapped within the physical structure of a feed ingredients (e.g., seed) that is comprised in the first solid composition or that is comprised within the physical structure of the first solid feed composition (e.g., extruded pellet). Such fats may be considered rumen inert because the fat or oil is not free to mix with other ingredients and does not affect digestion of other components in the rumen because it is comprised or trapped within the physical structure of the ingredients comprised in the first feed solid composition (e.g., seed) or the physical structure of the first solid feed composition (e.g., structure of an extruded pellet). It is therefore understood that at least a portion of the fat comprised in the first solid feed composition as taught herein may be any fat (need not be rumen inert by nature or need not be partially hydrogenated or fully hydrogenated) that is comprised or trapped within the physical structure of a feed ingredient comprised in the first solid feed composition (e.g., seed) or that is comprised within the physical structure of the first solid feed composition (e.g., when the first solid feed composition is an extruded pellet).

In an embodiment, the fat comprises or consists of a rumen inert fat (i.e., any fat that is not transformed or degradaded in the rumen, and preferably does not affect digestion of other components in the rumen). In a further embodiment, the fat may be a hydrogenated fat.

In an embodiment, the fat is not a saponified fat (e.g., calcium soap, saponified fatty acids).

In an embodiment, the hydrogenated fat may be selected from hydrogenated tallow fat and hydrogenated vegetable oil.

In a preferred embodiment, the fat is a partially or fully hydrogenated vegetable fat or oil such as partially or fully hydrogenated palm oil, partially or fully hydrogenated rapeseed oil, or partially or fully hydrogenated soybean oil or any mixture thereof.

In an embodiment, the fat is a fully hydrogenated fat such as a hydrogenated vegetable oil (e.g., fully hydrogenated palm oil, fully hydrogenated rapeseed oil, or fully hydrogenated soybean oil, or any mixture thereof).

The term “feed comprising fermentable feed ingredients” as used herein refers to a feed comprising fermentable carbohydrates and/or protein. Feed ingredients comprising fermentable carbohydrates and/or protein form the basis of solid feed compositions (e.g., starter compositions) fed to ruminant calves during the weaning period. Rumen fermentable carbohydrates are critical to optimize rumen microbial growth and fermentation, production of microbial protein and energy as volatile fatty acids (VFA). Non-limiting examples of rumen fermentable carbohydrates suitable for starter feed compositions include starch (e.g., as found in grains or cereals such as barley, corn, sorghum, wheat, oat, rye, and the like.), sugar (e.g., molasses, lactose, dextrose, sucrose, glucose, fructose, galactose, xylose, arabinose, beta-glucans, galactans, pectins, and the like), fermentable fibres (e.g., as found in forages such as straw, hay and the like or by-products such as beet pulp, citrus pulp, soy hulls and the like), as well as any mixture thereof.

Therefore, in an embodiment, the fermentable feed ingredients may be any feed ingredients comprising fermentable carbohydrates and/or fermentable proteins.

In a further embodiment, the fermentable feed ingredient comprising fermentable carbohydrates may be selected from grains such as barley, corn, sorghum, wheat, oat, rye, and the like, sugars such as molasses, lactose, dextrose, sucrose, glucose, fructose, galactose, xylose, arabinose, beta-glucans, galactans, pectins, and the like, and fermentable fibers such as found in forages such as straw, hay and the like or by-products such as beet pulp, citrus pulp and the like) as well as any mixture thereof.

In an embodiment, the fermentable feed ingredient comprising fermentable proteins may be selected from soybean meal, DDGS, lupins, and sunflower meal, rapeseed meal.

In an embodiment, the solid feed combination as taught herein comprises one or more additional separate solid feed compositions (e.g., a third solid feed composition, a fourth solid feed composition, and so on) comprising one or more fermentable feed ingredients. For instance, the solid feed combination composition as taught herein may comprise 3, 4, 5, or more solid feed compositions (e.g., in the form of separate feed pellets or muesli or grains).

In an embodiment, the first solid feed composition, which is in the form of a pellet (e.g., an extruded pellet), and the second solid feed composition may comprise substantially the same fermentable feed ingredients.

In an embodiment, the first solid feed composition, which is in the form of a pellet (e.g., an extruded pellet), and the second solid feed composition may comprise substantially different fermentable feed ingredients.

Preferably, the solid feed combination is not in the form of a feed block. Instead, it is preferred that the solid feed combination comprises a free-flowing mixture of the first solid feed composition and the second solid feed composition. This allows for homogeneous mixing of the two compositions, which ensures ingestion by the ruminant calf of both compositions in the desired ratio.

In an embodiment, both the first solid feed composition and the second solid feed compositions are both in the form of a pellet comprising one or more fermentable ingredients. In an embodiment, the pellets have substantially the same size. It was found that when the pellets have essentially the same size, it improves their mixability. Further, it was found that the ruminant calf does not discriminate between pellets or does not have a preference for a type of pellet. In other words, it was found that regardless of the composition of the pellets, i.e., one pellet having at least 20 wt. %, such as between 20 and 90 wt. %, of fats, for instance, rumen inert fats, and the other having less than 5 wt. % fats, the ruminant calf ate both pellets without a preference for a particular pellet. A further advantage of having pellets that are substantially the same size is that the pellets can be readily mixed together to form an homogeneous mixture without one type of pellet sinking to the bottom of the feeding bin or bucket. This further contributes to increase the intake of both pellets without discrimination by the ruminant calf. The same effect is observed when the solid feed combination composition as taught herein comprises a third, fourth, fifth solid feed compositions, and so on, in the form of pellets having substantially the same size as the first and second pellets.

In an embodiment, the first solid feed composition and the second solid feed compositions may be of a different size provided that the ratio of quantities provided of the larger component to smaller components is <1, i.e., the larger component is less abundant than the smaller component. An example of such situation is when the first solid feed composition, which is in the form of a pellet (e.g., an extruded pellet) comprising one or more fermentable feed ingredients has a larger size than the second solid feed composition (e.g., meals) and the ratio first solid feed composition (e.g., extruded pellet) to second solid feed composition (e.g., meals) is e.g., [10:90]. Under such condition, it was found that mixability of the first and second solid feed component was good (i.e., homogeneous mixture without having the larger component sinking at the bottom of the feeding bin or bucket or without the ruminant calf having a preference for either of the pellets).

In an embodiment, the first solid feed composition is preferably in the form of an extruded pellet. This was found to be particularly advantageous since it allows the inclusion of relatively high levels of fat (e.g., between 20-90 wt. % of fat such as hydrogenated fat, e.g., 20 wt. %, 25 wt. %, 30 wt. %, 35 wt. %, 40 wt. %, 45 wt. %, 50 wt. %, 55 wt. %, 60 wt. %, 65 wt. %, or 70 wt. % of hydrogenated palm oil), as discussed above. Such extruded pellets were also found to meet the industry standards for pellet hardness and durability, which are desirable or suitable for ruminant calves.

In an embodiment, the ratio between the first solid feed composition, which is in the form of a pellet (e.g., an extruded pellet) comprising one or more fermentable feed ingredient relative to the second compositions is between 30:70 to 1:99, such as, for instance, 25:75 to 5:95, 25:75 to 2:98, 20:80 to 8:92, or 15:85 to 10:90, depending on the fat content of the first solid feed composition.

In an embodiment, the solid feed combination composition as taught herein may further comprise additional nutrients such as vitamins (e.g., vitamins A, B, C, D, E, etc.) and minerals (e.g., sodium, phosphorus, calcium, etc.) as well as medicine (e.g., antibiotics). The skilled person knows how to select (if needed) adequate nutrients suitable for inclusion in the solid feed compositions for use in the combination as taught herein.

In an embodiment, the ruminant calf may be selected from the group of dairy calf, beef calf, veal calf, sheep lamb, goat kid, buffalo calf, moose calf, elk calf, bison calf, giraffe calf, yak calf, deer calf, antelope calf, preferably a dairy or a beef calf.

Methods of the Disclosure

In a second aspect, this disclosure relates to a method for reducing weaning stress or weaning dip of a ruminant calf during and/or after the weaning period, the method comprising the step of feeding to the ruminant calf the solid feed combination as taught herein during and/or after the weaning period.

The term “weaning stress” as used herein refers to any stress experienced by a ruminant calf during and/or after the weaning period. For instance, weaning stress may include emotional stress and physiological stress caused by transitioning a ruminant calf from milk or liquid diet to solid feed diet. Specifically, weaning stress may be manifested in the form of e.g., reduced ability to digest and consume solid feed, digestive problems causing pain, intestinal tract problems such as increased gut permeability (e.g., leaky gut), diarrhea or other infections, body weight loss, somatic growth loss (e.g., height), energy deficits (due to insufficient nutrition), delays in rumen development or maturation and others. Any of the consequences of weaning stress, e.g., on body weight, somatic growth, health, solid feed intake, etc may also be referred to as “weaning dip”. It was found that the solid feed combination composition as taught herein may be advantageously used to reduce the weaning stress or weaning dip experienced by a ruminant calf (e.g., dairy calf, beef calf) during and/or after the weaning period.

In a further aspect, this disclosure relates to a method for increasing, or rather, preventing a decrease in somatic growth of a ruminant calf during and/or after the weaning period, the method comprising the step of feeding to the ruminant calf the solid feed combination as taught herein during and/or after the weaning period.

The term ‘somatic growth’ as used herein refers to growth of the body in terms of height and/or body weight. Somatic growth is also understood to refer to a positive change in size (i.e., gain in height and/or body weight), for example, over a period of time (e.g., at the end of the weaning period or other time point(s) during the weaning period). In this disclosure, somatic growth is determined by recording the body weight and/or height of a ruminant calf (e.g., dairy calf, beef calf) before the onset of the weaning period and at the end of the weaning period or at a particular time point during the weaning period. Specifically, somatic growth is determined by subtracting the body weight and/or height measured after feeding the solid feed combination composition as taught herein to the ruminant calf during the weaning period (i.e., body weight and/or height is measured at the end the weaning period or a particular time point during the weaning period) from the body weight and/or height measured before feeding the solid feed combination composition (i.e., body weight and/or height is measured just before the onset of the weaning period). This can be done using the following formulas:

For Body Weight:

Somatic growth=[body weight before onset of weaning period]−[body weight after termination of the weaning period or at one or more particular time(s) point during the weaning period]). For instance, the weaning period may be at least about 5-10 weeks, e.g., at least about 5 weeks, 6 weeks, 7 weeks, 8 weeks, 9 weeks, 10 weeks or more. The weaning period may be shorter, e.g., 1-2 days up to 10 weeks or more such as 1-2 days, 5 days, 10 days, 15 days, 20 days, 25 days, 30 days, 40 days, 50 days, 60 days, 70 days, 80 days, 90 days, 100 days, 110 days, 120 days, 130 days, 140 days, 150 days, 160 days, 170 days, 180 days, 190 days, 200 days, 250 days, 300 days or more. The one or more particular time point(s) during the weaning period may be, for instance, at 1 day, 2 days, 5 days, 10 days, 15 days, 20 days, 25 days, 30 days, 35 days, 42 days, 49 days, 56 days, 63 days, or 70 days. The ruminant calf may be of any age, for example, the ruminant calf may be about 5 to 12 weeks of age or younger such as 0-1 week of age, 2 weeks of age, 3 weeks of age, or 4 weeks of age, when the weaning period is initiated. The same principle applies to determining changes in somatic growth (body weight) in the post-weaning period.

Or for Height:

Somatic growth=[height before the onset of the weaning period]−[height after the termination of the weaning period or at one or more particular time(s) point during the weaning period]). For instance, the weaning period may be at least about 5-10 weeks, e.g., at least about 5 weeks, 6 weeks, 7 weeks, 8 weeks, 9 weeks, 10 weeks or more. The weaning period may be shorter, e.g., 1-2 days up to 10 weeks or more such as 1-2 days, 5 days, 10 days, 15 days, 20 days, 25 days, 30 days, 40 days, 50 days, 60 days, 70 days, 80 days, 90 days, 100 days, 110 days, 120 days, 130 days, 140 days, 150 days, 160 days, 170 days, 180 days, 190 days, 200 days, 250 days, 300 days or more. The one or more particular time point(s) during the weaning period may be, for instance, at 1 day, 2 days, 5 days, 10 days, 15 days, 20 days, 25 days, 30 days, 35 days, 42 days, 49 days, 56 days, 63 days, or 70 days. The ruminant calf may be of any age, for example, the ruminant calf may be about 5 to 12 weeks of age or younger such as 0-1 week of age, 2 weeks of age, 3 weeks of age, or 4 weeks of age, when the weaning period is initiated. The same principle applies to determining changes in somatic growth (height) in the post-weaning period.

For instance, an increase in body weight (e.g., grams or kilograms) in response to feeding the solid feed combination composition as taught herein during and/or after the weaning period indicates an increase in somatic growth at the end of the weaning period or at one or more specific time points during the weaning period and/or post-weaning period while a decrease or no change in body weight indicates a decreased or unchanged somatic growth at the end of the weaning period or at one or more specific time points during the weaning period and/or post-weaning period, respectively. Further, an increase in height (e.g., cm or m) in response to feeding the solid feed combination composition as taught herein during and/or the weaning period or at one or more specific time points during the weaning period and/or post-weaning period indicates an increase in somatic growth while a decrease or no change in height indicates a decreased or unchanged somatic growth at the end of the weaning period or at one or more specific time points during the weaning period and/or post-weaning period, respectively. It was found that the solid feed combination composition as taught herein may be advantageously used to increase somatic growth (both body weight and height) of a ruminant calf (e.g., dairy calf, beef calf) during and/or after the weaning period.

In a further aspect, this disclosure relates to a method for reducing morbidity and/or mortality of a ruminant calf during and/or after the weaning period, the method comprising the step of feeding to the ruminant calf the solid feed combination as taught herein during and/or after the weaning period.

The term “decreasing morbidity and/or mortality” of a ruminant calf (e.g., dairy calf, beef calf) refers to a situation where morbidity (being diseased) and/or mortality of ruminant calves caused by diseases such as infection or caused by malnutrition is reduced or prevented. As a result, the ruminant calf (e.g., dairy calf, beef calf) is healthier (not diseased) and not at risk or less at risk of dying from a disease and/or malnutrition. It was found that the solid feed combination composition as taught herein may be advantageously used to decrease or prevent morbidity and/or mortality” of a ruminant calf (e.g., dairy calf, beef calf) during and/or after the weaning period.

In a further aspect, this disclosure relates to a method for increasing solid feed intake of a ruminant calf during and/or after the weaning period, the method comprising the step of feeding to the ruminant calf the solid feed combination as taught herein during and/or after the weaning period.

The term ‘feed intake’ or ‘solid feed intake’ as used herein refers to the amount (volume or weight) of solid feed voluntarily ingested by a ruminant calf (e.g., dairy calf, beef calf) in a certain period of time, for instance, in one day. In this disclosure, feed intake may be determined by weighting and recording, on a daily basis, the amount of feed provided at a time point 0 (for instance, at the beginning of the day around 8 AM) and the amount of leftover feed is typically measured 24 hours later (for instance, around 8 AM on the next day). Feed intake is calculated by subtracting the amount of solid feed not eaten at the end of the day from the amount of solid feed provided to a ruminant calf at the beginning of the day, where the day is any day during the weaning period. Feed intake may be calculated daily during and/or after the weaning period or on one or more specific days during and/or after the weaning period. Feed intake on a given day may be calculated as follows:

Feed intake=[amount (e.g., grams) of feed provided at the beginning of the day]−[amount (e.g., grams) of feed left intact (i.e., not eaten) at the end of the day]). It was found that the solid feed combination composition as taught herein may be advantageously used to increase solid feed intake of a ruminant calf (e.g., dairy calf, beef calf) during and/or after the weaning period.

In a further aspect, this disclosure relates to a method for maturing the rumen of a ruminant calf during and/or after the weaning period, the method comprising the step of feeding to the ruminant calf the solid feed combination as taught herein during and/or after the weaning period.

The term “for maturing the rumen of a ruminant calf” as used herein refers to a situation where the rumen acquires the ability to ferment feeds and produce or extract sufficient energy thereof for sustaining the ruminant's energetic nutritional needs. Maturation of the rumen begins when bacteria colonize the rumen. Milk often is one of the first sources of rumen microbes. When solid/dry feed enters the rumen, it creates an environment that further promotes microbes to grow and the microbiome to develop and differentiate. As microbes grow and metabolize nutrients, they produce volatile fatty acids. The primary volatile fatty acids produced in the rumen are acetic, propionic, and butyric acids. This acid production lowers the pH of the rumen and establishes an even better environment for bacteria to continue their growth, especially for bacteria that digest fermentable carbohydrates such as starch and produce acetic, propionic and butyric acids. Calf starter solid feed compositions often contain fermentable carbohydrates in the form of starch (derivable from grains), which is fermented by bacteria that produce acetic, propionic and butyric acids. Therefore, the state of maturity of the rumen of a ruminant calf can be assessed by determining the ability of the rumen to ferment feed (e.g., feed comprising fermentable carbohydrates such as starch) by measuring, for instance, levels (%) of acetic, propionic acid, butyric acids as well as others compounds such as valeric acid, iso-butyric acid, iso-valeric acid and volatile fatty acid, by assessing microbial colonization and diversity, or by the intake of fermentable feeds. The development and adaptations of the rumen can be assessed by rumen mass and gene expression. Other methods to assess rumen development in calves include measuring papillae length, width, and density using microscopy, and more recently, three-dimensional imaging of rumen tissue for morphometric analysis using micro-computed tomography (Steele et al., 2014). For instance, in a newborn calf, the size of the rumen, abomasum, omasum and reticulum is approximately 25%, 60%, 10%, and 5% of the whole digestive system, respectively. In a mature ruminant, the size of the rumen, abomasum, omasum and reticulum is approximately 80%, 7%, 8%, and 5% of the whole digestive system. It was found that the solid combination composition as taught herein may be advantageously used for maturing (e.g., increase maturation) the rumen of a ruminant calf (e.g., dairy calf, beef calf) during and/or after the weaning period.

In a further aspect, this disclosure relates to a method for maturing a ruminant calf into an adult having an improved health status, the method comprising the step of feeding to the ruminant calf the solid feed combination as taught herein during and/or after the weaning period. The term “health status” as used herein refers to the health (good or poor) of an animal (e.g., ruminant calf or adult ruminant) or person, group or population in a particular area, especially when compared to other animals, persons, groups or areas. Health status is determined by more than the presence or absence of any disease. It also includes life expectancy (long or short) as well as mental well-being and functioning of the body. In the context of this disclosure, improved or increased or enhanced health status refers to a situation when a ruminant calf or adult ruminant, throughout its lifespan, is substantially healthy, such as being disease-free, pathogen-free, having adequate or improved body weight, development and/or height for age/gender, well developed and functional gastrointestinal tract, producing adequate or high quality milk or meat or other products (e.g., leather, wool, etc.), having adequate or improved body function (e.g., reproduction, digestion, immune system, etc.), and others.

It was found that the solid combination as taught herein may be advantageously used during and/or after the weaning period for maturing a ruminant calf (e.g., airy calf) into an adult (e.g., dairy cow) having an improved health status.

In a further aspect, this disclosure relates to a method for maturing a ruminant calf into an adult having a more productive status, the method comprising the step of feeding to the ruminant calf the solid feed combination as taught herein during and/or after the weaning period. The term “productive status” as used herein refers to a state in which an animal (e.g., ruminant) yields or produces an increased amount of products such as milk, meat, leather, wool, etc. The term productive status also includes situations where an animal (e.g., ruminant) yields or produces products having higher or enhanced quality. It further includes situations where an animal (e.g., ruminant) delivers an increased amount of offspring and/or healthier or heavier offspring.

It was found that the solid combination as taught herein may be advantageously used during and/or after the weaning period for maturing a ruminant calf (e.g., dairy calf, beef calf) into an adult (e.g., dairy cow) having a more productive status.

In a further aspect, this disclosure relates to a method for improving gut health and/or gastrointestinal function of a ruminant calf, the method comprising the step of feeding to the ruminant calf the solid feed combination as taught herein during and/or after the weaning period.

The term “gut health” or “gastrointestinal function” as used herein refers to the effective functionality of the gut or gastrointestinal tract in terms of digestion of feeds and absorption of nutrients. It also includes the effective functionality of the immune system, the microbiome (i.e., where commensal bacteria (beneficial bacteria) are enriched and pathogens (undesirable or detrimental bacteria) are absent or low amount), and structural integrity of the gut mucosa (e.g., well-developed and well-functioning mucus layer, epithelium and gastrointestinal barrier (e.g., no or minimal leakage in or out), etc.). In the context of this disclosure, improved or increased or enhanced gut health or gastrointestinal function refers to a situation when a ruminant calf or adult ruminant, throughout its lifespan, has a substantially healthy gut or a substantially healthy gastrointestinal function such as having an adequate or improved digestion and absorption of feed, having an adequate or improved gut immune system, having an adequate or improved microbiome that is enriched in beneficial bacteria and devoid or having minimal amounts of detrimental bacteria or pathogens, and/or having an adequate or improved structural integrity of the gut mucosa, and others.

It was found that the solid feed combination as taught herein may be advantageously used during and/or after the weaning period for improving gut health and/or gastrointestinal function of a ruminant calf (e.g., dairy calf, beef calf).

The term “weaning period” as used herein refers to the period of time needed to complete the transition from milk only (e.g., milk replacer or maternal milk) to solid feed only. For instance, when the transition from milk to solid feed is performed gradually (e.g., milk supply is gradually decreased and solid feed is gradually introduced), the weaning period will encompass the time spanning from the onset of introducing solid feed, until the moment (time) when weaning is completed, i.e., when milk supply is completely withdrawn and diet consists of solid feed only. For instance, considering that it takes on average about 8 weeks to develop the rumen from the initial time a solid diet rich in fermentable carbohydrate and/or proteins (e.g., grains) is fed to the ruminant calf the weaning period may last about 5-10 weeks or longer, e.g., about 5 weeks, about 6 weeks, 7 weeks, 8 weeks, 9 weeks, 10 weeks or longer. Depending on the situation, the weaning period may also be shorter, e.g., 1-2 days up to 10 weeks or more such as 1-2 days, 5 days, 10 days, 15 days, 20 days, 25 days, 30 days, 40 days, 50 days, 60 days, 70 days, 80 days, 90 days, 100 days, 110 days, 120 days, 130 days, 140 days, 150 days, 160 days, 170 days, 180 days, 190 days, 200 days, 250 days, 300 days or more.

In an embodiment relating to any of the methods as taught herein, the weaning period may last until the time where milk replacer or maternal milk is completely withdrawn from the ruminant calf and replaced by a diet consisting of solid feed only. As explained herein, it is understood that the weaning process may begin when milk or milk replacer is still supplied to the ruminant calf (albeit gradually reduced) and solid feed is gradually supplied next to milk or milk replacer. This can be at various time points during early life of the ruminant calf, depending on the weaning strategy employed (e.g., at 5-12 weeks of age or younger e.g., 0-4 weeks of age, as indicated above). In other words, the ruminant calf (e.g., dairy calf, beef calf) may be any age when the weaning process is initiated and thus may be fed the combination composition as taught herein during the weaning process or period irrespective of its age.

The term “post-weaning” or “post-weaning period” as used herein refers to a period of time taking place after weaning has been completed, i.e., when the milk supply is completely withdrawn and the diet consists of solid feed only. It is understood that the age of a ruminant calf during the post-weaning period (i.e., age at which the weaning process is finalized, i.e., ruminant eats solid feed only and milk supply is completely withdrawn) will depend on the weaning strategy employed in a farm or commercial operation, type of ruminant calf, the health status of the calf, etc.

In an embodiment relating to any one of the methods as taught herein, the ruminant calf may be fed the solid feed combination as taught herein for at least about 1 week, e.g., about 1 week, about 2 weeks, about 3 weeks, about 4 weeks, about 5 weeks, about 6 weeks, about 7 weeks, about 8 weeks, about 9 weeks, about 10 weeks, or more.

In an embodiment, the solid feed combination as taught herein may be fed in any manner suitable for feeding a ruminant calf, preferably ad libitum.

In an embodiment relating to any one of the methods as taught herein, the ruminant calf may be selected from the group of dairy calf, beef calf, veal calf, sheep lamb, goat kid, buffalo calf, moose calf, elk calf, bison calf, giraffe calf, yak calf, deer calf, antelope calf, preferably a dairy or a beef calf.

Uses of the Disclosure

In a further aspect, this disclosure relates to the use of the solid feed combination as well as methods as taught herein for: 1) reducing weaning stress or weaning dip of a ruminant calf during and/or after the weaning period, and/or 2) for increasing somatic growth (e.g., increasing body weight and/or height) of a ruminant calf during and/or after the weaning period, and/or 3) for decreasing morbidity and/or mortality (e.g., as caused by diseases such as infection) of a ruminant calf during and/or after the weaning period, and/or 4) for increasing solid feed intake of a ruminant calf during and/or after the weaning period, 5) for maturing the rumen of a ruminant calf during and/or after the weaning period, 6) for maturing a ruminant calf into an adult having an improved health status, 7) for maturing a ruminant calf into an adult having a more productive status (e.g., increased milk or meat production) and/or 8) for improving gut health and/or gastrointestinal function of a ruminant calf (e.g., improved digestion and/or absorption of feed, improved immune function, improved structural integrity of the gut, present leaky gut, etc.), and other advantages.

In an embodiment, the benefits obtained in ruminant calves with the solid feed combinations or mixtures taught herein are relative to results obtained in ruminant calves (of the same species) fed a conventional starter feed. Such conventional starter feed preferably comprises one or more fermentable feed ingredients and contain less than 5 wt. %, preferably less than 4 wt. %, even more preferably less than 3 wt. %, fat.

In an embodiment, the weaning period is as defined above and the ruminant calf is selected as defined above. It is understood that any of the preferences described above also apply here.

Further, the advantages associated with the use of the solid feed combination composition as well as methods as taught herein for the purposes described above are as defined herein as well as in the examples.

It is understood that the solid feed combination as taught herein as well as the methods as taught herein may be used for any ruminant calf, irrespective of the age of the calf or weaning strategy and/or post-weaning strategy employed. In other words, the solid feed combination as taught herein as well as the methods as taught herein may be used in situations where early weaning is desired (e.g., at 5-12 weeks of age or earlier as indicated above) or in situations where weaning occurs naturally or later in life and/or may be used after weaning.

### EXAMPLES

### Example 1: Effects of Various Starter Diets on Energy Intake and Performance of Ruminant Calves

The objective of this study was to determine the effects of feeding a solid feed combination composition, according to this disclosure, to a young ruminant calf during the weaning period on: 1) energy intake (solid feed intake), and 2) weaning performance (body weight gain).

Experimental Procedure

The study was conducted at IRTA (Department of Ruminant Production, Barcelona, Spain) and included 75 female Holstein new-born calves derived from one single farm. All calves participating in the study were kept and managed under standard production conditions.

Experimental Groups

The female Holstein new-born calves (n=75) were randomly assigned to one of 5 experimental groups (n=15/group) as set out below (see Table 1 for summary):

Group 1: A single pellet consisting of a solid feed composition (pellet B) comprising fermentable feed ingredients and less than 5 wt. % of fat. The first solid feed composition (pellet A) is omitted. The ratio first solid feed composition (pellet A) to second solid feed composition (pellet B) was [0:100].

Group 2: A solid feed combination composition comprising two separate pellets, namely a first solid feed composition comprising fermentable feed ingredients (extruded pellet A) comprising 40 wt. % of rumen inert fat (fully hydrogenated palm fatty acids) combined with a second solid feed composition (pellet B) comprising fermentable feed ingredients and less than 5 wt. % of fat. The ratio first solid feed composition (pellet A) to second solid feed composition (pellet B) was [10:90].

Group 3: A solid feed combination composition comprising two separate pellets, namely a first solid feed composition comprising fermentable feed ingredients (extruded pellet A) comprising 40 wt. % of rumen inert fat (fully hydrogenated palm fatty acids) combined with a second solid feed composition (pellet B) comprising fermentable feed ingredients and less than 5 wt. % of fat. The ratio first solid feed composition (pellet A) to second solid feed composition (pellet B) was [20:80].

Group 4: A solid feed combination composition comprising two separate pellets, namely a first solid feed composition comprising fermentable feed ingredients (extruded pellet A) comprising 40 wt. % of rumen inert fat (fully hydrogenated palm fatty acids) combined with a second solid feed composition (pellet B) comprising fermentable feed ingredients and less than 5 wt. % of fat. The ratio first solid feed composition (pellet A) to second solid feed composition (pellet B) was [30:70].

Group 5: A single pellet consisting of a solid feed composition (pellet C) comprising fermentable feed ingredients and 11 wt. % of rumen inert fat (hydrogenated palm fatty acids). This experimental condition combines the ingredients of the first solid composition (pellet A) with the ingredients of the second solid feed composition (pellet B) into a single pellet (pellet C). This diet was nutritionally similar to the diet of experimental group 2.

Treatment Duration

Calves from each experimental group were exposed to their respective diet from 3-5 days from their birth date until they reached the age of 84 days from their birth date (corresponds to 4 weeks post-weaning).

TABLE 1
Overview of experimental diets. Pellet A consists of high-fat extruded
pellet comprising fermentable feed ingredients (corresponds to the
first solid composition according to this disclosure). Pellets A
were prepared using an extrusion process in combination with vacuum
coating technology in order to allow the inclusion of high levels
of fat (e.g., 40 wt. %) while maintaining good hardness and durability
of the pellets (see Table B for list of ingredients). Pellet B consists
of a classic fermentable starter pellet (corresponds to the second
solid feed composition according to this disclosure). See table
C for the list of ingredients comprised in pellet B. Pellet C consisted
of a single pellet starter having a high fat content (corresponds
to the first and second solid feed compositions, according to this
disclosure, combined into a single pellet instead of two separate
pellets, see Table D for the list of ingredients). All pellets (A,
B and C) were isonitrogenous (have the same nitrogen content) and
had similar mineral contents to avoid potential bias or effects
on intake, growth, and metabolic parameters.

| | | Pellet A | Pellet B | |
|---|---|---|---|---|
| | | [Wt. % of the | [Wt. % of the | |
| | Calves | combination | combination | Pellet C |
| Groups | (n) | composition] | composition] | [Wt. %] |
| 1. | 15 | 0 | 100 | 0 |
| 2. | 15 | 10 | 90 | 0 |
| 3. | 15 | 20 | 80 | 0 |
| 4. | 15 | 30 | 70 | 0 |
| 5. | 15 | 0 | 0 | 100 |

TABLE B
Composition of pellet A

| | Pellet A |
|---|---|
| Ingredients | [Wt. % of the combination composition] |
| hydrogenated palm fatty acids | 40.00 |
| corn gluten meal | 15.80 |
| Corn | 12.50 |
| Wheat | 10.20 |
| soy bean meal | 10.00 |
| beet pulp | 6.00 |
| Molasses | 1.80 |
| Minerals | 1.77 |
| Limestone | 1.53 |
| premix and additives | 0.40 |

TABLE C
Composition of pellet B

| | Pellet B |
|---|---|
| Ingredients | [Wt. % of the combination composition] |
| Corn | 34.70 |
| soy hulls | 13.60 |
| Wheat | 9.70 |
| soy bean meal | 8.20 |
| beet pulp | 7.60 |
| corn gluten meal | 7.30 |
| wheat bran | 6.64 |
| rapeseed meal | 5.00 |
| Molasses | 4.40 |
| Limestone | 1.45 |
| Minerals | 1.01 |
| premix and additives | 0.40 |

TABLE D
Composition of pellet C.

| | Pellet C |
|---|---|
| Ingredients | [Wt. % of the combination composition] |
| Corn | 30.24 |
| soy hulls | 11.0 |
| Wheat | 10.00 |
| Corn gluten meal | 9.00 |
| soy meal | 8.52 |
| hydrogenated palm fatty acids | 8.00 |
| beet pulp | 6.66 |
| wheat gluten | 5.31 |
| Molasses | 4.40 |
| rape seed meal | 4.00 |
| Limestone | 1.44 |
| Minerals | 1.03 |
| premix and additives | 0.40 |

Feeding and Housing

Within the first 6 h of life, calves received 3.5 L of colostrum. Calves were fed 3.0 L of milk replacer twice a day at 125% dilution for the first week, and then 3 L/feeding at 15% dilution—900 g/d until 49 days of age. Then, milk replacer was offered at 3.0 L also at 15% but once daily (450 g/d) until 56 days of age when calves were fully weaned. For the duration of the trial, calves had ad libitum access to the treatment starter diet and chopped straw (provided in a separate bucket), and water. Calves were individually housed on sawdust and bottle-fed throughout the study.

Measurements

Growth performance and feed intake.

Calves were weighed (using weigh scales) and sized (height) (using a height stick) upon arrival and on a weekly basis until the end of the study. Individual milk replacer and solid feed consumption were determined daily. Feed efficiency was then calculated weekly. Water intake was not recorded. The average daily weight gain (ADG) was derived from dividing the weakly measurement by 7.

Results

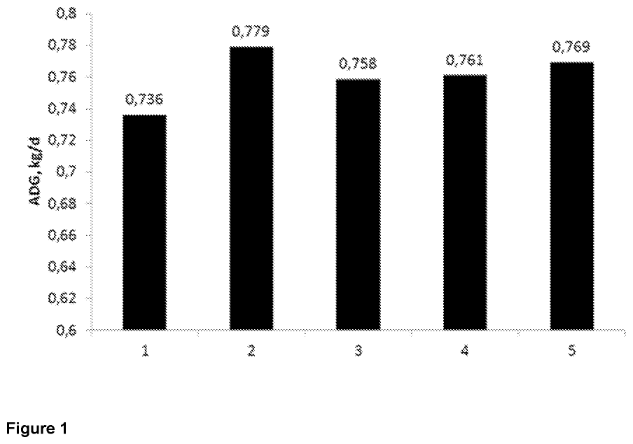

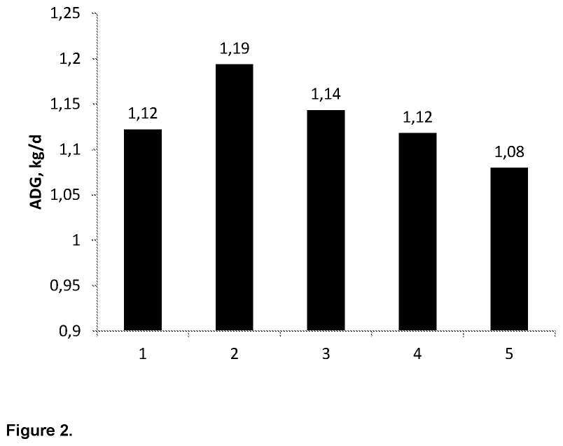

The results are presented in FIGS. 1 and 2 as well as Table 2 below.

Body Weight Gain (Grams/Day)

The results show that calves, which were fed a solid feed combination composition comprising pellet A and B in a ratio of 10:90 (diet of group 2) display greater average daily body weight gain (kg) than calves fed the other diets (diets of group 1, 3, 4, and 5) (see Table 2 and FIGS. 1 and 2).

Further, it can be observed that the average daily weight gain (ADG) (in grams/day) during the weaning period (FIG. 1) and post-weaning (FIG. 2) were highest in calves fed with the diet of group 2 compared to the other diets (diets of group 1, 3, 4, and 5).

The data also show that average daily weight gain (grams/day) post-weaning (FIG. 2) was lowest in calves fed with pellet C (diet of group 5). Comparison between the calves receiving the diet of group 2 and calves receiving the diet of group 5 shows that providing the fat source (high amount of rumen inert fat) within the fermentable fraction is not effective. It was found that delivering dietary fat by feeding a ruminant calf with a solid feed combination composition comprising an extruded high-fat pellet (pellet A) and a fermentable starter pellet (pellet B) results in greater average daily gain (grams/day) around weaning compared to situations where calves are fed a single fermentable starter pellet (pellet B, group 1), or a single pellet with increased fat content (pellet C, group 5).

TABLE 2
Growth performance and solid feed intake of young
calves fed various diets during the weaning period.

| | Experimental groups | | | | |
|---|---|---|---|---|---|
| Parameters | 1 | 2 | 3 | 4 | 5 |
| ADG (g/d) | 866 | 903 | 879 | 872 | 856 |
| Solid feed (g/d) | 1,337 | 1,527 | 1,375 | 1,304 | 1,224 |

Abbreviations: ADG (g/d) = average daily weight gain (grams/day).

Solid Feed Intake (Kg/Day)

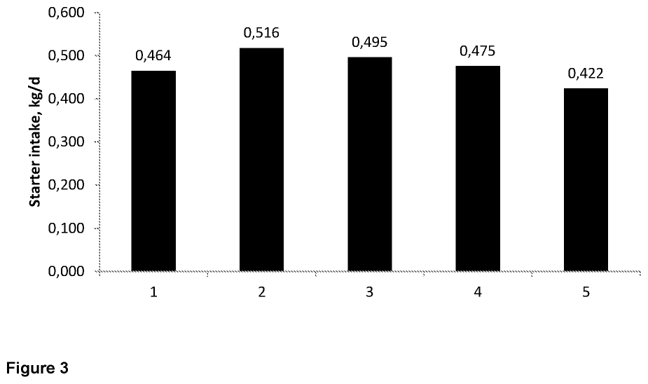

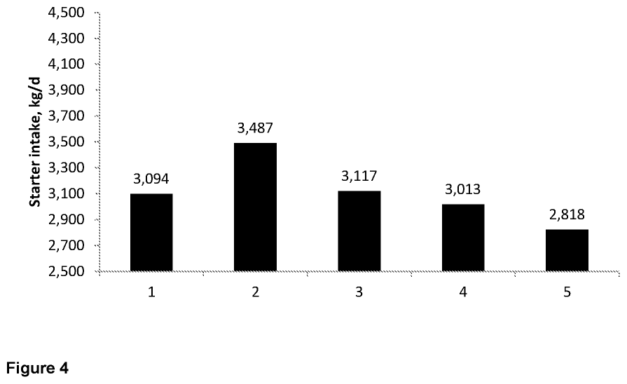

Solid feed intake performances are depicted in Table 2 and FIGS. 3 and 4. Solid feed intake (Kg/day) in the weaning period was greatest in calves that were fed the diet of group 2 compared to calves fed with the other diets (diets of group 1, 3, 4, and 5)(FIG. 3). Further the results show a difference of about 400 grams/day in intake in the post-weaning period in calves that were fed the diet of group 2 compared to calves fed with the other diets (diets of group 1, 3, 4, and 5) (FIG. 4). The data also show that solid feed intake (was lowest for the pelleted starter with higher fat content in both periods, i.e., group 5. In fact, the comparison between group 2 and 5 shows that providing the fat source within the fermentable fraction into a single pellet is not effective when aiming for high fat intake.

1.-23. (canceled)

24. A method for feeding a ruminant calf, the method comprising:
administering to the ruminant calf a solid feed combination, the solid feed combination comprising:
at least a first solid feed composition and a second solid feed composition,
wherein the first solid feed composition is in a form of a pellet comprising between 20 and 90 wt. % of fat, and one or more fermentable feed ingredients selected from starch and fibers,
wherein the second solid feed composition comprises one or more fermentable feed ingredients, the second solid feed composition being in the form of a pellet, meal, muesli, or grain, or any mixture thereof, and
wherein the total fat content of the solid feed combination is in the range of 5-20 wt. %.

25. The method according to claim 24, wherein the second solid feed composition has at most 5 wt. % fat.

26. The method according to claim 24, wherein the solid feed combination comprises one or more additional solid feed compositions comprising one or more fermentable feed ingredients.

27. The method according to claim 24, wherein the fat in the first solid composition comprises or consists of a rumen inert fat.

28. The method according to claim 27, wherein the rumen inert fat is selected from the group consisting of partially or fully hydrogenated fatty acids, partially or fully hydrogenated fats, and mixtures thereof.

29. The method according to claim 24, wherein the one or more fermentable feed ingredients comprises fermentable carbohydrates.

30. The method according to claim 29, wherein the fermentable carbohydrates include sugars.

31. The method according to claim 24, wherein the solid feed combination consists of a mixture of the first solid feed composition and the second solid feed composition.

32. The method according to claim 24, wherein the second solid feed composition is in the form of a pellet.

33. The method according to claim 24, wherein the first solid feed composition is in the form of an extruded pellet.

34. The method according to claim 33, wherein the first solid feed composition is produced by extruding the fermentable feed ingredients to obtain an extruded pellet, and vacuum coating the extruded pellet using the fat.

35. The method according to claim 24, wherein the solid feed combination is a mixture with a fixed ratio on weight basis of the first solid feed composition relative to the second solid feed composition.

36. The method according to claim 24, wherein the ratio of the first solid feed composition relative to the second solid feed composition is in the range of 30:70 to 1:99 on a weight basis.

37. The method according to claim 24, wherein the ruminant calf is selected from the group consisting of dairy calf, beef calf, veal calf, sheep lamb, goat kid, buffalo calf, moose calf, elk calf, bison calf, giraffe calf, yak calf, deer calf, and antelope calf.

38. The method according to claim 24, wherein the solid feed combination is administered during weaning of the ruminant calf.

39. The method according to claim 24, which reduces weaning stress of the ruminant calf during and/or after a weaning period.

40. The method according to claim 24, which prevents a decrease in somatic growth due to weaning of the ruminant calf during and/or after a weaning period.

41. The method according to claim 24, which increases solid feed intake of the ruminant calf during and/or after a weaning period.

42. The method according to claim 24, which matures rumen of the ruminant calf during and/or after a weaning period of the ruminant calf.

43. The method according to claim 24, wherein the ruminant calf has an improved health compared to a ruminant calf being fed a conventional starter feed.

44. The method according to claim 24, which improves gut health and/or gastrointestinal function of the ruminant calf.

45. The method according to claim 24, wherein the ruminant calf is fed the solid feed combination for one week.

46. The method according to claim 24, wherein the solid feed combination is fed ad libitum to the ruminant calf.
